(19) United States
(12) Patent Application Publication
(10) Pub. No.: US 2021/0249925 A1
(43) Pub. Date: Aug. 12, 2021

(54) STRANDED CONDUCTOR, COIL DEVICE, AND PRODUCTION METHOD

(71) Applicant: Rolls-Royce Deutschland Ltd & Co KG, Blankenfelde-Mahlow (DE)

(72) Inventors: Harald Müller, Gerhardshofen (DE); Andreas Schröter, Heroldsbach (DE)

(21) Appl. No.: 16/972,576

(22) PCT Filed: Jun. 3, 2019
(86) PCT No.: PCT/EP2019/064260

§ 371 Date: Dec. 4, 2020

(30) Foreign Application Priority Data
Jun. 8, 2018 (DE) 10 2018 209 157.9

(51) Int. Cl. H02K 3/28; H02K 15/04; H02K 9/19

(52) U.S. Cl. CPC H02K 3/28; H02K 9/19; H02K 15/0421

(57) ABSTRACT

The invention relates to an electrical conductor (1), which is designed as a stranded conductor and comprises a bundle of a plurality of electrically conductive individual wires (3), the individual wires (3) being connected to each other by a cured filler (5) to form a superordinate conductor structure and the conductor (1) having at least one internal coolant channel (9), which runs in a longitudinal direction of the conductor (1) and is sealed fluid-tight from the regions (11) of the stranded conductor that lie further outward, the distance (d) between coolant channel (9) and the closest individual wires (3) of the bundle being at most 1 mm. The invention further relates to an electrical coil device (21) having a conductor (1) of this type and to a method for producing a conductor (1) of this type.

This application is the National Stage of International Application No. PCT/EP2019/064260, filed Jun. 3, 2019, which claims the benefit of German Patent Application No. DE 10 2018 209 157.9, filed Jun. 8, 2018. The entire contents of these documents are hereby incorporated herein by reference.

### BACKGROUND

The present embodiments relate to an electrical conductor, an electrical coil device that has an electrical coil winding including one or more electrical conductors of this kind, and a production method for a conductor of this kind.

According to the prior art, stranded conductors, which include a large number of bundled individual wires, are used in many electrical applications. Stranded conductors of this kind have the advantage of reduced alternating-current losses over solid conductors with a comparable cross section. The individual wires within a stranded conductor of this kind are often electrically insulated from one another. This provides that eddy currents may propagate only within an individual wire of the stranded bundle and no longer within the entire cross-sectional area of a conductor of solid construction. Even if the individual wires are not completely insulated from one another, the division into individual wires already reduces the propagation of eddy currents. In any case, a reduction in the alternating-current losses is achieved by limiting the conductor cross section that is available to the eddy currents.

In many electrical applications, especially when operating electrical coil devices, the achievable current densities are limited by the possibilities for cooling the conductor. The most effective and efficient cooling possible is therefore desirable. Further, the operating temperature may be reduced by effective cooling, this generally reducing the ohmic losses. In coil devices with stranded conductors, the conductors are frequently cooled by way of a fluid coolant flowing past the outside of the stranded conductor. Therefore, there is direct contact between a fluid coolant and the stranded conductor, this generally being beneficial for effective cooling. However, particularly in the case of stranded conductors with relatively large cross sections, it is disadvantageous that the individual wires that are situated further on the inside are then primarily connected to the cooling arrangement much more poorly than the individual wires that are situated further on the outside and are thermally more closely coupled to the coolant flowing past. The thermal coupling of the internal individual wires to the coolant flowing past is difficult primarily when the individual wires are surrounded by a thermally comparatively poorly conductive insulation layer. In addition, there is frequently still additional cured filler within the stranded conductor; the filler connects the individual wires to a superordinate conductor structure. A filler of this kind may also have a negative effect on the thermal coupling of the individual wires to the fluid coolant. This problem may easily lead to overheating in the internal region of the stranded conductor, primarily in applications with comparatively high current densities.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, a conductor that overcomes the disadvantages mentioned is provided. For example, a conductor that may be effectively cooled, so that local overheating may be avoided, and in which the alternating-current losses may be reduced at the same time, is provided. As another example, an electrical coil device that has a coil winding including one or more conductors of this kind is provided. As yet another example, a production method for a conductor of this kind is provided.

The electrical conductor according to the present embodiments is configured as a stranded conductor and has a bundle including a large number of electrically conductive individual wires. In this case, the individual wires are connected to one another by a cured filler to form a superordinate conductor structure. The conductor has at least one internal coolant duct that extends along a longitudinal direction of the conductor and is sealed off in a fluid-tight manner from the regions of the stranded conductor that are situated further on the outside. In this case, the distance between the coolant duct and the closest individual wires of the bundle is at most 1 mm.

Owing to the described internal coolant duct, a waveguide that may be effectively cooled by a coolant flowing through the waveguide on the inside is formed by the stranded conductor. In this way, local overheating in the internal region of the conductor may also be avoided at comparatively high current densities. Cooling from the outside may additionally be used as an option. The internal coolant duct is to allow direct cooling in the conductor interior. In order to be able to cool this conductor as a whole (e.g., within a closed coolant circuit), it is advantageous when this internal coolant duct is sealed off in a fluid-tight manner from the regions of the conductor that are situated further on the outside. However, in principle, design variants in which a leak from the inside to the outside (e.g., through a porous structure including individual wires) may be tolerated may also be provided. In a variant of this kind, a hydraulic pressure is created on the winding layers; as a result of this, mechanical weakening may be caused in principle. This should be avoided in most applications. However, when this may be tolerated, a leak of coolant radially through the stranded bundle may be acceptable in principle.

The fluid-tight sealing that is desired in many cases may be realized in two different ways in principle: First, primary sealing may be created by the filler of the stranded conductor (e.g., by an impregnating resin between the individual wires of the stranded bundle). In this case, no additional pipe wall between the coolant duct and the bundle comprising individual conductors is required. However, as an alternative or additionally, the fluid-tight sealing may also be provided by an additionally provided pipe wall that is arranged between the coolant duct and the surrounding individual wires. However, in this variant, the thickness of this additional wall may be limited to at most 1 mm. The fluid-tight sealing provides that no coolant may enter the regions between the individual wires.

An advantage of the conductor according to the present embodiments is that effective removal of heat from the surrounding individual wires may take place owing to the close physical proximity of the coolant duct to the individual wires. Both in the variant without an additional pipe wall (e.g., given a distance of 0) and in the variant with an additional thin pipe wall (and the corresponding distance d), there is therefore close thermal coupling of the individual wires to the fluid coolant flowing in the duct. In addition, the small thickness of the optionally provided pipe wall has a beneficial effect on the achievable fill factor of the conductive material of the individual wires.

Therefore, both the limiting of the alternating-current losses (e.g., owing to the subdivision into individual wires) and also effective cooling and therefore a high current density may be achieved with the stranded conductor according to the present embodiments.

The electrical coil device according to the present embodiments has an electrical coil winding including one or more electrical conductors according to the present embodiments. The advantages of the coil device result analogously to the advantages of the electrical conductor that are specified above.

The method according to the present embodiments serves for producing an electrical conductor according to the present embodiments. The method includes the following acts: a) arranging a bundle of individual wires around at least one internal elongate core; b) jointly pressing the bundle of individual wires and the internal core to form a stable and compact composite; c) filling the conductor composite with a filler and then curing the filler; and d) forming the coolant duct by removing at least a portion of the core.

The conductor according to the present embodiments may be produced in a particularly simple manner using a method of this kind. For example, the subsequent removal of at least a portion of the core allows a well-defined internal cooling duct that is thermally closely coupled to the individual wires to be formed. For example, it is not necessary in this production method for there to be a particularly thick additional pipe wall in order to define the cooling duct. Since the cooling duct may be formed by subsequent removal of a material of the core, no pipe wall of this kind is required at all or a comparatively thin pipe wall is sufficient. For example, this remaining pipe wall may be so thin that, without the internal filling, the remaining pipe wall would not withstand the pressing in act b) without the cooling duct being compressed. In other words, the portion of the pressed-together core that is subsequently removed in act d) allows a defined internal cavity to be formed. The cavity would have been compressed during pressing without the material that fills the cavity. Therefore, in other words, the entire core or at least the portion of the core that is subsequently removed serves for defining the volume of the future cooling duct and for keeping this volume free for the future cooling duct despite the high forces that act from the outside during pressing.

The described refinements of the conductor, of the coil device, and of the production method may be combined with one another.

Therefore, the distance between the coolant duct and the closest individual wires of the bundle may be limited to, for example, at most 0.7 mm or at most 0.5 mm. In other words, the thickness of the pipe wall that is optionally present may be limited to the distance values mentioned. In general, it is also possible and, under certain circumstances, advantageous when the distance is zero, and therefore, there is no additional pipe wall at all. The distance values should not include the thickness of a wire insulation that is optionally present (e.g. the distance values should always be the distance between the internal cooling duct and the outer side of the closest individual wire including corresponding insulation).

According to an embodiment, the conductor has an additional pipe wall between the bundle of individual wires and the coolant duct. The additional pipe wall delimits the coolant duct in a fluid-tight manner. This pipe wall may have, for example, a thickness in one of the distance ranges mentioned (e.g., a wall thickness of at most 1 mm). In this case, the coolant duct is formed by removing a filling from the region in the interior of the pipe wall. The advantages of a conductor according to this embodiment result analogously to the advantages of the above-described production method in the corresponding variant with a pipe wall. A conductor that is produced in this way may be identified, for example, in that the individual wires are so strongly compressed within the stranded conductor and the pipe wall is so thin that, without the protective filling, the cavity of the coolant duct would have been compressed during pressing.

In the embodiment with an additional pipe wall, the material of the pipe wall may have a thermal conductivity of, for example, at least 5 W/m·K. The thermal coupling between the coolant and the surrounding individual wires is particularly good at such a high thermal conductivity. The particularly thin configuration of the pipe wall also serves for improved thermal coupling.

In general, the material of the pipe wall may be an electrically conductive material. An electrically conductive material may be advantageous since the pipe wall may then act as an additional individual conductor. However, a thin wall thickness of the pipe wall is also advantageous in this variant, so that the alternating-current losses within the pipe wall do not become too high. Preferred materials for an electrically conductive pipe wall of this kind are, for example, copper or aluminum and, respectively, alloys containing copper and/or aluminum as a constituent part. However, as an alternative, the pipe wall may also include an electrically insulating material (e.g., a correspondingly thermally conductive plastic and/or a correspondingly thermally conductive composite material). In this case, the choice of a material for the pipe wall is also dependent on the level of aggression of the coolant used (e.g., on whether the coolant would dissolve plasticizer out of a plastic used) or whether a silicone-containing coolant that would dissolve a silicone-containing plastic is used. In general and irrespective of the choice of material, the thin pipe wall may be thicker than the diameter of the respective individual wires.

However, as an alternative to the abovementioned embodiment, the electrical conductor may also be configured without an additional pipe wall of this kind. The distance between the coolant duct and the closest individual wires of the bundle may therefore be 0, for example. In this embodiment, the coolant duct is delimited directly by the bundle of individual wires that is connected by the cured filler, so that the coolant duct is sealed off in a fluid-tight manner by the composite including individual wires and coolant. One advantage of this design variant is the even closer thermal coupling of the individual wires to the coolant flowing in the coolant duct. A further advantage may be considered that of the loss of cross-sectional surface area being limited and therefore a higher fill factor of individual wires being able to be achieved in the variant without an additional pipe wall. Therefore, the internal channel then directly adjoins the individual wires and/or the cured filler.

In principle, both embodiments (e.g., with and without an additional pipe wall) may be produced using the production method, specifically by keeping free the volume for the coolant duct by at least a portion of the pressed-together core.

In general, the individual conductors within the bundle may be stranded and/or braided with one another. An arrangement of this kind, in which the position of the individual conductors varies over the length of the bundle, is particularly advantageous for limiting alternating-current losses.

According to an embodiment, the conductor may have a plurality of internal coolant ducts that are each formed in the same way, for example. These coolant ducts may be configured to be identical to one another, for example (e.g., all with a pipe wall or all without a pipe wall). However, in principle, it is possible and, under certain circumstances, advantageous when the individual cooling ducts vary with respect to cross-sectional shape and/or cross-sectional area.

In general, the individual conductors within the bundle may be pressed together to form a stable and compact composite. By way of pressing in this way under a relatively high pressure, a comparatively high fill factor of the conductive material of the individual wires may be realized, for example. This fill factor (e.g., the surface area proportion of the wire material in the entire cross section of the conductor composite) may therefore, for example, be at least 60%, at least 70%, or at least 75%. For example, fill factors of up to 80% or even up to 85% may generally be achieved by strong compression.

In general, the number of individual wires in an electrical conductor may be at least a few tens. The electrical conductor may include for example, at least 100 or at least 500 individual wires of this kind.

According to a variant, the electrical conductor may be configured as a prefabricated, dimensionally stable conductor segment for a coil device. In other words, the conductor may be a preformed conductor segment of which the shape is no longer changed during production of the coil device. The term “dimensionally stable” may be, in the present context, that the conductor may no longer be wound. This dimensional stability is achieved by the cured filler. For example, the conductor may even be so dimensionally stable that the shape of the conductor may no longer be changed without destruction after the filler is cured.

A dimensionally stable conductor segment of this kind may be, for example, a conductor segment of a hairpin winding. These windings are formed from individual hairpin-shaped winding sections. In this case, a conductor segment of a hairpin winding of this kind may form, for example, a complete hairpin or half a hairpin. For example, a hairpin segment of this kind may have a straight conductor section and one or two inclined conductor sections that adjoin the straight conductor section, where the straight conductor section and the inclined conductor section are respectively connected to one another by kinks. Short, straight end pieces that form the connection points to other conductor segments of this kind may optionally adjoin each of the inclined conductor sections. In general, conductor segments of this kind may be formed, for example, in the manner of an elongated “Z” or in the manner of an extended trough-shaped “U”.

However, as an alternative to the abovementioned variant, it is also possible and, under certain circumstances, advantageous when the conductor is configured as a malleable conductor. In this embodiment, a residual flexibility therefore remains even after the filler is cured, so that the conductor may still be wound into the shape of an electrical coil even after the curing. It is possible to form any desired coil shapes using a conductor of this kind (e.g., types of windings other than hairpin windings or windings composed of rigid conductor sections may also be formed thereby).

According to an embodiment, the cross-sectional area of the coolant duct is greater than the cross-sectional area of an individual wire. For example, the cross-sectional area of the coolant duct may be at least 5 times or at least 10 times the cross-sectional area of an individual wire. As a result, a correspondingly high coolant flow through the duct may be achieved.

In general, the electrical conductor may have any desired cross-sectional shape. In this case, the geometry is determined, for example, by the shape of the tool used during pressing. For example, the conductor may have a round (e.g., circular) or rectangular cross section or else a cross section of another polygon (e.g., with straight and/or rounded connecting lines). Analogously, the at least one internal coolant duct may also have any desired cross-sectional shape, where the shape may be chosen independently of the cross-sectional shape of the conductor as a whole.

The material of the individual wires may be, for example, an electrically highly conductive material (e.g., copper or aluminum) and, respectively, an alloy containing copper and/or aluminum as a constituent part.

In general, the individual wires of the stranded conductor may be encased by an insulation material over a major portion of their longitudinal extent. An electrical insulation of the individual wires in this way is expedient in order to keep alternating-current losses in the stranded conductor low. An insulation material of this kind may include, for example, a polymer (e.g., a polymer lacquer) or else an electrically insulating oxide. This insulation material has, for example, a comparatively high thermal conductivity. The same applies to the filler used. In general, it is advantageous when the material of the filler is fluid-tight with respect to the coolant used. The coolant may be, for example, cooling water or a cooling oil. The filler may be chosen, for example, such that the filler is chemically curable at room temperature and is resistant to higher operating temperatures. For example, the filler may be a two-component adhesive or a two-component potting agent.

According to an embodiment of the electrical coil winding, the coil winding is configured as a hairpin winding. A hairpin winding of this kind may be produced in a particularly simple manner from prefabricated, dimensionally stable conductor segments having the features of the present embodiments.

However, as an alternative, the coil winding may also be any desired other winding (e.g., a flat coil and/or a toothed coil). The coil winding may be a winding including one or more individual coils of this kind or else a distributed winding. In general, the coil device may optionally have a soft-magnetic coil core or a soft-magnetic yoke.

The coil device may have a closed system for circulating a fluid coolant (e.g., a liquid coolant). The internal coolant duct of the stranded conductor may then be a portion of the closed cooling circuit. In addition, the coil device may then optionally also have one or more coolant chambers and also optionally further cooling ducts. For example, the coil device may have an end-winding chamber from which coolant may be fed into the interior of the stranded conductors in the axial end region of the winding. An end-winding chamber of this kind may be realized, for example, in a similar manner to that in German patent application DE 102017204472.1.

According to an embodiment of the production method, the core used is a solid core rod (e.g., a core that initially does not have an internal cavity). A solid core rod of this kind may withstand particularly high pressure forces during pressing of the conductor composite.

In general, the method acts may be carried out in the specified order; however, the sequence of the acts is initially arbitrary in principle. Therefore, acts a) and b) may, for example, also be executed so shortly one after the other that the combination of these two acts may also be considered to be an integrated operation. An integrated method of this kind is present, for example, in the method of roller profiling advantageously employed. A roller profiling machine allows long stranded conductors of this type to be stranded and pressed in one operation.

In general, preprofiling may also be performed before the pressing in act b) (e.g., preprofiling of the stranded bundle to a cross section that differs from the circular shape and/or to a compact shape with a defined fill factor of conductor material within the bundle cross section). This reduces the shaping forces that are required during subsequent pressing and provides particularly good utilization of the winding space.

It is also possible to interchange the specified order in acts b) and c). Alternatively, act b) and act c) or part of act c) may be combined with one another: For example, the conductor composite may be filled with the filler before pressing and curing may be performed, for example, during pressing.

In general, either the entire core or an internal portion of the core may be removed using a physical and/or chemical process in act d). For example, the portion of the core that is to be removed may be melted out by increasing the temperature. Therefore, in general, the core may be a fusible core. To this end, it is advantageous when the portion of the core that is to be removed has a melting point of 160° C. or less (e.g., below 140° C. or even below 100° C.). For example, the portion of the core may be an alloy with a correspondingly low melting point that includes tin, lead, bismuth, and/or cadmium (e.g., a Wood's metal, a Lipowitz's metal and/or a Newton's metal). However, as an alternative, the portion of the core that is to be removed may also contain an organic material with a correspondingly low melting point (e.g., a wax or a paraffin). In general, it is advantageous when the material of the filler of the stranded conductor is chosen such that the filler is sufficiently stable after curing in act c) at a temperature above the melting point of the core material to be removed. In general, this is also advantageous so that the filler may withstand the temperatures that occur during operation of the coil device. For example, the filler may have a use temperature range that, at temperatures of, for example, 180° C., still allows compliance with insulation class H for the winding. In this temperature range, the filler may then also be sufficiently fluid-tight to the coolant flowing in the coolant duct.

With selection of a material with a correspondingly low melting point, the portion of the core that is to be removed may be removed in a relatively simple manner by heating and simultaneously flushing this material. If the material is particularly easy to melt, it may even be sufficient to flush the duct to be formed with a hot flushing liquid (e.g., with hot, distilled water). The fusible material may then be easily separated off (e.g., by filtration) after the flushing liquid has cooled down and the material has solidified.

However, as an alternative to the described process of melting out the core material to be removed, it is also possible for this material to be removed by physically-chemically being dissolved out. In this variant, the material to be removed may be flushed out by a solvent, where a temperature increase may once again optionally take place in order to facilitate the dissolving-out operation.

In a variant of the method, the core has an external casing and an internal filling, where in act d), only the filling is removed, and the casing remains as the pipe wall between the coolant duct and the individual wires. The filling may then be formed, corresponding to the manner described above, from a material that has a low melting point or may be readily dissolved, while the casing has a considerably higher melting point or is considerably more difficult to dissolve. In this case, the casing may also consist of a mechanically harder material than the internal filling. A harder casing material of this kind serves for mechanical stabilization during the pressing process in act b) since the material to be removed (e.g., the filling) may, under certain circumstances, be so soft that it would not penetrate into the intermediate spaces between the individual wires during pressing without a casing of this kind. This can be effectively prevented by the additional casing by way of the casing acting as a hydraulic support for the soft internal filling. For this function, the casing, which remains in the finished electrical conductor as the pipe wall around the coolant duct, need not be particularly thick. The casing may, for example, be configured to be considerably thinner than would be necessary in order to withstand the pressing process without an internal filling, without the internal coolant duct then being pushed in. Since there is a core rod with an external, thin hard casing and an internal soft filling in the interior of the stranded bundle during pressing in this variant, considerably higher compressions and therefore considerably higher fill factors of the individual wires may be achieved during pressing than in a comparable hollow pipe without an internal filling.

According to a further variant of the method, the following additional act may optionally be performed after act c): e) bending of the conductor into a shape that is suitable for producing an electrical coil device.

This act e) may be performed before or after the above-described act d). The shaping of the conductor in act e) may, for example, be performed before the core material is removed in act d) since the coolant duct is then kept free during the bending by the internal material that is still present. However, particularly in the case of relatively large bending radii, it is also possible to first remove the internal material in act d) and only then bend the conductor into the corresponding final shape in act e).

The act e) (e.g., the shaping of the conductor for producing the winding) may be performed before or after act c) (e.g., the application and curing of the filler). As an alternative, act e) may also be performed at the same time as the filler is applied (e.g., corresponding to a wet-winding method, in which an impregnation agent is supplied during the winding operation). The filler may then be cured in an act that follows the winding operation or even during the production of the further parts of the winding.

The shape into which the conductor is bent may be, for example, the shape of a hairpin segment. However, any other desired shape may be produced, and therefore, any desired winding may be produced (e.g., a flat coil, a core coil, and/or a distributed winding).

The production method may optionally include the following additional act: f) electrically contacting the conductor (e.g., in one or in both end regions).

Contact of this kind may be made, for example, by crimping and/or soldering and/or welding. In a contacting process of this kind, the coolant duct may be kept free in the contacted region by a supporting sleeve or a mandrel, so that the duct is not closed by the forces or temperatures that occur during the contacting. In a further method act, in addition to electrical contacting, a hydraulic fitting may optionally be mounted in the end region of the conductor in order to be able to conduct the coolant or a flushing liquid from the conductor end into the internal coolant duct or out of the duct.

### BRIEF DESCRIPTION OF THE DRAWINGS

FIG. 1 shows a schematic perspective illustration of a conductor according to a first exemplary embodiment, after method act c);

FIG. 2 shows an illustration of the conductor of FIG. 1 after method act d);

FIG. 3 shows a schematic cross-sectional illustration of a conductor according to a second exemplary embodiment, after method act c);

FIG. 4 shows a cross-sectional illustration of the conductor of FIG. 3 after method act d);

FIG. 5 shows a schematic perspective illustration of a conductor according to a third exemplary embodiment;

FIG. 6 shows a schematic longitudinal section through a terminal region of a conductor according to a fourth exemplary embodiment;

FIG. 7 shows a schematic longitudinal section of an electrical coil device according to a further example;

FIG. 8 shows an illustration of a detail of the right-hand-side contact region of a coil device of FIG. 7;

FIG. 9 shows a schematic cross-sectional illustration of a stator slot with a plurality of conductors; and

FIG. 10 shows a schematic cross section of a further coil device.

### DETAILED DESCRIPTION

In the figures, elements that are the same or have a same function are provided with the same reference signs.

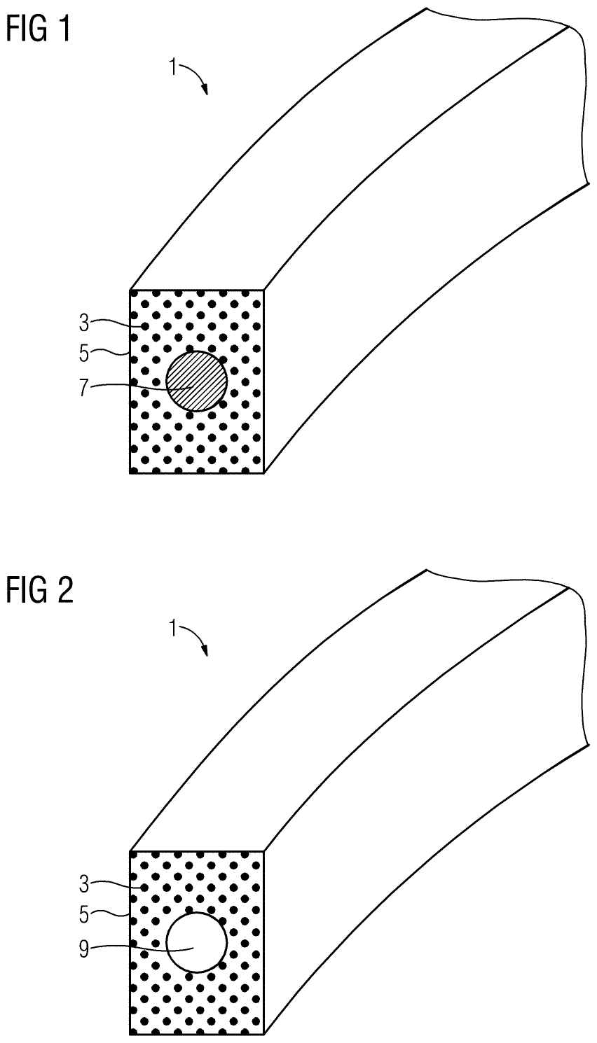

FIG. 1 shows a schematic perspective illustration of an electrical conductor 1 (e.g., a conductor) according to a first exemplary embodiment. FIG. 1 shows an intermediate product of the conductor 1 after carrying out acts a), b), and c) of a production method. This conductor 1 has a bundle including a large number of individual wires 3 that are arranged around an internal, elongate core 7 (e.g., a core or an internal core). These individual wires 3 have been pressed together with the internal core 7 to form a stable and compact composite. The conductor composite formed in this way has been filled with a filler 5, and the filler 5 has been cured. A mechanically stable conductor composite that has a rectangular cross section in the example shown was produced in this way. However, this cross-sectional shape is merely exemplary and in general may be chosen as desired. The filler 5 is chosen such that the conductor composite is fluid-tight after the filler 5 is filled and cured. However, the filler 5 may be so flexible that the entire conductor composite may still be bent even after the filler 5 is cured. However, as an alternative, the filler 5 may also be chosen such that the entire conductor composite is dimensionally stable after the curing and may no longer be moved without destruction.

The internal core 7 has been placed, as, for example, a core rod, between the individual wires 3 of the conductor composite before the pressing. In this example, this core 7 is formed completely from a material with a comparatively low melting point. This has the effect that the core 7 may be melted out of the intermediate product according to FIG. 1 by a comparatively small increase in temperature. Melting out in this way may be performed, for example, by heating the entire conductor composite and/or by flushing out by a flushing liquid (e.g., optionally heated). FIG. 2 shows the finished conductor after removal of the internal core rod 7 in this way. There is now an elongate coolant duct 9 (e.g., a coolant duct) in a center of the conductor 1, rather than the core 7, which was previously present. In the example shown, this coolant duct 9 directly adjoins the composite of individual wires 3 and the filler 5. In other words, the coolant duct 9 directly adjoints the composite of individual wires 3 and the filler 5 without an additional pipe wall. Fluid-tight sealing of the coolant duct 9 is achieved by, for example, the fluid-tight properties of the filler 5 that fills the intermediate spaces between the individual wires 3 in a fluid-tight manner. As a result, the coolant duct 9 is sealed off to such an extent that regions 11 of the conductor 1 that are situated further on an outside cannot be reached by a liquid coolant flowing in the coolant duct 9.

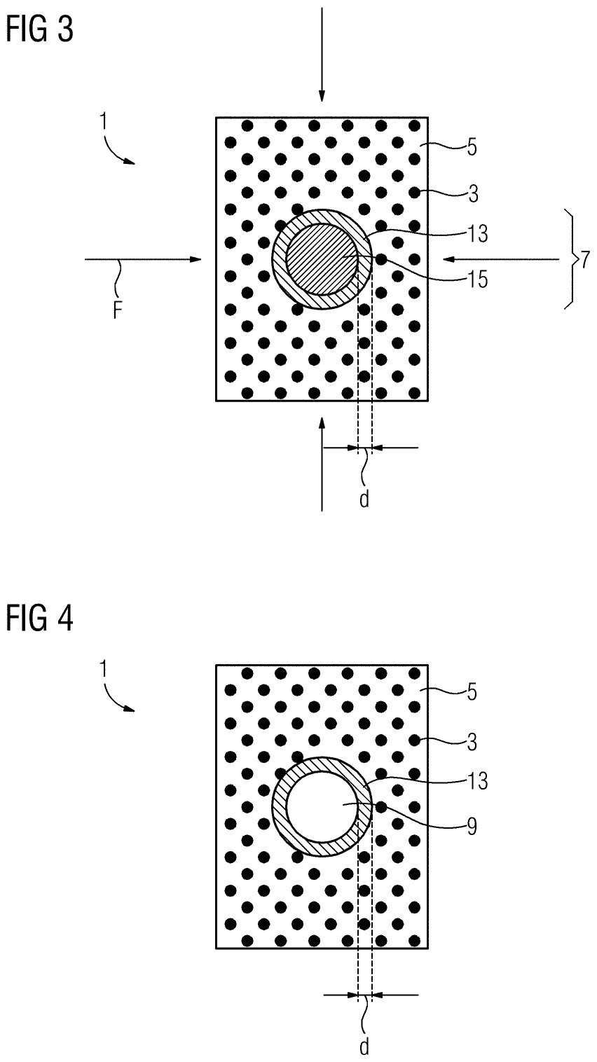

FIG. 3 shows a schematic cross-sectional illustration of a similar electrical conductor 1 according to a second exemplary embodiment. An intermediate product of the conductor 1 after carrying out method acts a), b), and c) is shown here too. In this case too, the conductor has a bundle including a large number of individual wires 3 that are arranged around an internal core 7 and are pressed together with the core 7 to form a compact composite. Here too, the intermediate space between the individual wires is filled by a cured filler 5 that may optionally be configured in a fluid-tight manner. In contrast to the example of FIG. 1, the internal conductor 7 is not formed from a homogeneous material, but rather, the internal conductor 7 has a concentric structure including an external casing 13 and an internal filling 15. The external casing 13 accordingly forms a pipe wall that is filled with the internal filling 15. In this case, a thickness d of the pipe wall is chosen to be comparatively thin. For example, the thickness d is chosen to be so thin that compression forces F that act toward an inside when the conductor is pressed would compress a region within the pipe wall 13 if the pipe wall 13 were not filled with the filling 15. However, since the filling 15 is present, relatively high compression forces F may be applied when this conductor is pressed, so that a particularly compact conductor composite with a particularly high fill factor of individual wires 3 may be realized. This fill factor is not illustrated approximately true to scale in the illustration of FIG. 3 (e.g., the surface area proportion of the material of the individual wires in the entire cross section may be substantially greater than illustrated). For example, the individual wires may even form a major proportion of the entire cross-sectional area.

FIG. 4 shows a similar cross-sectional illustration of the conductor 1 of FIG. 3 after the internal filling 15 has been removed. This filling may once again be removed either by melting and/or by being dissolved out using a solvent. Therefore, in this example too, the conductor 1 that is produced in this way has an internal coolant duct 9 through which a liquid coolant may flow for the purpose of cooling the conductor. However, in contrast to the preceding example, the coolant duct 9 is delimited by the stationary pipe wall 13 with the thickness d. This pipe wall 13 may already seal off the internal coolant duct 9 in a fluid-tight manner. As an alternative or in addition, the filler 5 may likewise be configured in a fluid-tight manner here too.

For example, when a relatively soft material is used for the filling 15 to be removed, the additional pipe wall 13 shown in FIGS. 3 and 4 may be advantageous in order to nevertheless achieve strong compression and therefore a correspondingly high fill factor when the conductor is pressed. Owing to the surrounding pipe wall 13, ingress of the soft filling 15 into the intermediate spaces between the individual wires 3 may also be avoided in the case of strong compression.

FIG. 5 shows a schematic perspective illustration of a conductor 1 according to a third exemplary embodiment. In contrast to the two preceding examples, this conductor 1 has a plurality of internal coolant ducts 9. Three internal coolant ducts 9 of this kind are illustrated by way of example in the conductor shown, but this number may also be considerably higher. In this case, these coolant ducts 9 may be sealed off from the other regions of the conductor once again either without an additional pipe wall, as in FIG. 2, or with an additional pipe wall 13 for each coolant duct, as in FIG. 4.

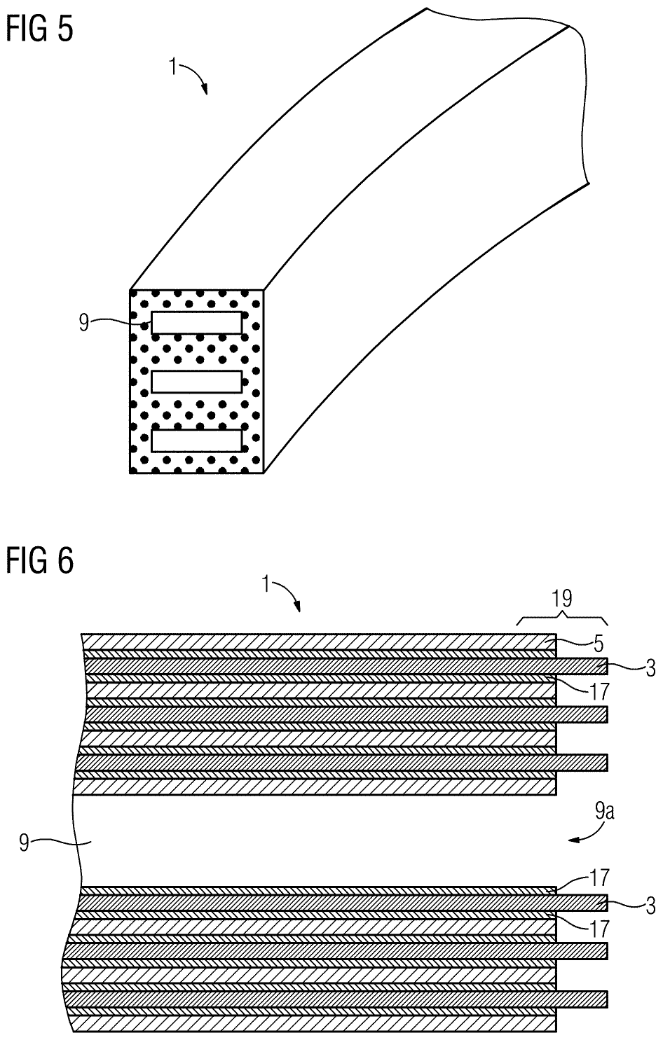

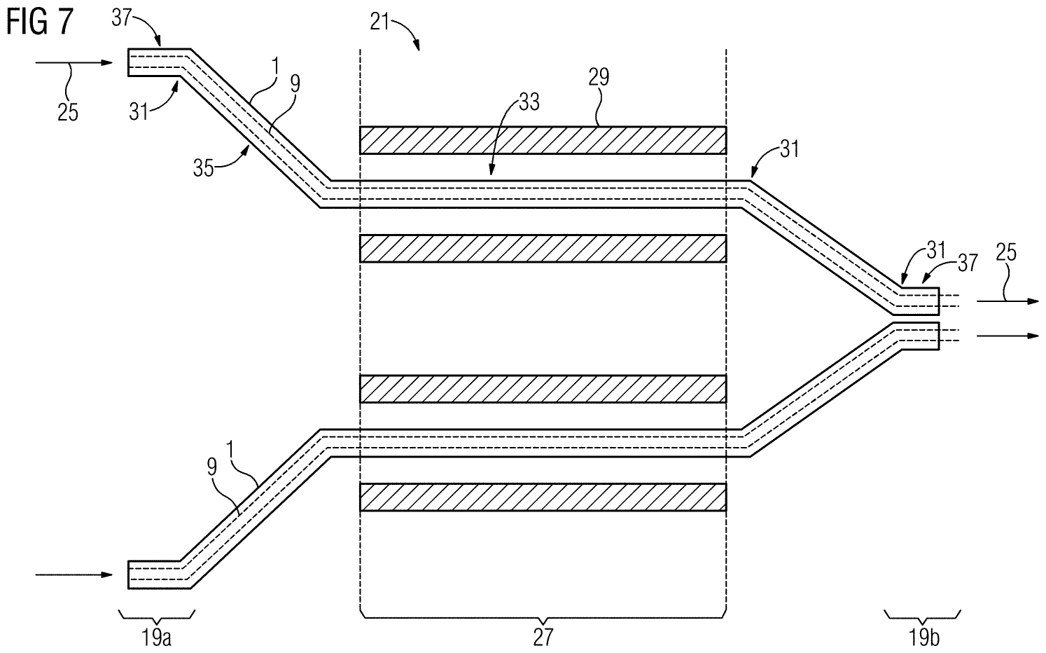

FIG. 6 shows a schematic longitudinal section through an end region of a conductor 1 according to a fourth exemplary embodiment (e.g., with a sectional plane parallel to the longitudinal direction of the conductor). The conductor 1 also has a bundle of individual wires 3 that surround an internal coolant duct 9 on all sides. Three individual wires 3 of this kind are shown on each side of the cross section (e.g., above and below the coolant duct 9). However, these are each also representative of a substantially larger number of individual wires of this kind in the entire conductor.

These individual wires 3 are each surrounded by an electrically insulating insulation material 17 (e.g., optional) over the major portion of the length of the electrical conductor 1. The individual wires that are insulated in this way are once again jointly embedded into a filling material 5. The filling material may either have been cast as potting agent in a potting process around the individual wires 3 that were previously pressed together, or the filling material may have been applied around the individual wires 3 as the impregnation agent in an impregnation process. In any case, the filling material 5 has been cured after being introduced between the individual wires 3, so that the electrical conductor is provided with increased mechanical strength and dimensional stability as a result. Both insulation material 39 and also filler 40 have been removed from the end region 19 shown in which the electrical conductor 1 may be contacted; however, these are both optional. The individual wires 3 of the conductor may now be electrically connected (e.g., by crimping, welding, or soldering) to a further conductor segment of this kind and/or an external electrical circuit via an electrical contact point in this region. The individual wires 3 of the stranded conductor are twisted or stranded together over the length of the stranded conductor, but this is not shown in FIG. 6 for reasons of clarity.

In the example of FIG. 6, the internal coolant duct 9 is not delimited by an additional pipe wall. Rather, the coolant duct 9 is delimited directly by the individual wires 3 of the stranded conductor 1 or conductor insulation 17 of the individual wires 3 that are connected to the filler 5. The duct 9 may therefore locally adjoin either the wires 3, as illustrated in the lower portion of FIG. 6, or the duct 9 may locally adjoin the filler 5, as illustrated in the upper portion of FIG. 6. The intermediate spaces between the individual wires 3 are sealed off in a fluid-tight manner by the filler 5, so that the regions of the conductor 1 that are situated further on the outside and, for example, the area surrounding the outside of the conductor may not be reached by a coolant flowing in the coolant duct 9. Supply or discharge of coolant into or from this duct 9 may be performed by the terminal openings 9a in the corresponding end regions 19 of the conductor 1.

FIG. 7 shows a schematic longitudinal section through an electrical coil device 21 according to a further example. The coil device 21 may be, for example, a portion of a stator winding of an electrical machine. The stator winding is constructed as a hairpin winding, and the detail of FIG. 7 shows two electrical conductors 1 that are each configured as a hairpin segment and together form a hairpin-shaped structure. The longitudinal section shown in FIG. 7 is a sectional illustration with a sectional plane parallel to the main axis of the machine or of the stator. In the central region 27 (e.g., an axially internal region) of the stator, the two hairpin segments each have relatively long straight conductor sections 33 that extend in the axial direction. In this central region 27, the stator has a soft-magnetic yoke 29, into the slots of which axial conductor sections 33 are embedded. Each of the conductors 1 shown has in each case two kinks 31 in end regions adjoining the conductors 1. There is a respective inclined conductor section 35, by way of which the distance (e.g., in the circumferential direction) between the individual axial conductor segments may be bridged, between these two kinks 31 on each side. There are still short contact regions 37, in each of which adjacent hairpin segments may be electrically contacted with one another, in axial end regions 19a and 19b that adjoin the inclined conductor sections.

As indicated by arrows 23 and 25, a coolant flow from left to right takes place through each of the conductor segments 1 shown. In other words, coolant is fed into the internal coolant ducts 9 of the individual conductors 1 in the end region of the stator that is illustrated on the left-hand side. In contrast, coolant is conducted out of these coolant ducts again 9 in an axial end region of the stator that is illustrated on the right-hand side. The feeding-in in the part of the stator that is illustrated on the left-hand side may be performed, for example, for the individual conductor segments jointly out of a superordinate end-winding chamber. In the portion of the stator that is illustrated on the right-hand side, the coolant again exits from the coolant ducts 9 owing to the excess pressure and may accordingly be collected and supplied to the coolant circuit again as desired.

The individual hairpin segments 1 from the example of FIG. 7 may be produced, for example, as prefabricated, dimensionally stable conductor segments, where the filler 5 used may be so hard that the individual conductor segments 1 may no longer be bent after the filler is cured. In other words, the shaping at the kinks 31 shown may be performed after the conductor is pressed, but before the filler 5 is cured, here. The internal core material (or at least the filling of the core) may be removed for the purpose of forming the coolant ducts 9 after the conductors are shaped and after the filler is cured.

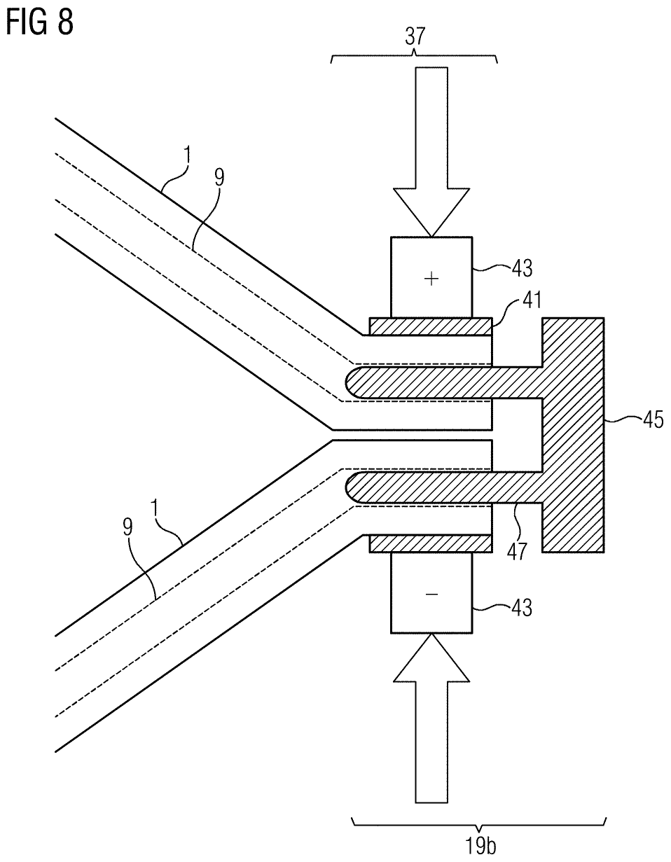

FIG. 8 shows a detail of the electrical coil device 21 from FIG. 7. More specifically, FIG. 8 shows a detail in an area surrounding the contact regions 37 illustrated on the right-hand side. In order to be able to electrically connect the two conductor segments 1 shown in the end regions 19b thereof to form a superordinate coil, the corresponding contact regions 37 are enclosed together by a sleeve 41 and pressed together with this sleeve between two opposite plungers 43 that may be energized. Owing to the corresponding pressure (as indicated by the double arrows) and a current flow between the two plungers 43, the two contact regions 37 of the two conductors 1 may be electrically connected to one another either by pure hot-pressing or crimping and/or via an additional welding or soldering layer, not illustrated in any more detail here. Owing to the heating and the pressing by the two plungers 43, the individual wires of the stranded conductors are fused together within the contact regions 37, so that there is no longer any actual stranded conductor in these end regions. In order to nevertheless keep the end regions of the coolant ducts 9 open during this contacting process, suitable mandrels may be inserted into the openings of the ducts during the heating and pressing. FIG. 8 shows, by way of example, how a protective element 45 with two suitable mandrels 47 is temporarily inserted into the two conductor ends such that the two duct openings are kept open. After this supporting element 45 is removed, the two corresponding duct openings may each be provided with a suitable hydraulic fitting in order to either feed in or conduct out coolant or flushing liquid here.

The described process of keeping the duct openings free by the protective element 45 may be performed, in principle, before or after the core material is removed (e.g., before or after the coolant duct is exposed) in the remaining portion of the conductor length. In other words, the coolant ducts in the conductors 1 may already be exposed before the contacting, and the protective element 45 then protects the end regions that are under heavy loading during the contacting. Alternatively, the material to be removed is removed (e.g., by local heating or immersion into a heated flushing liquid), for example, only in the end regions in a first act, the end regions are contacted after the protective element 45 is attached, and the coolant duct 9 is only then exposed in the rest of the conductor region by removing the core material or a portion of the core material).

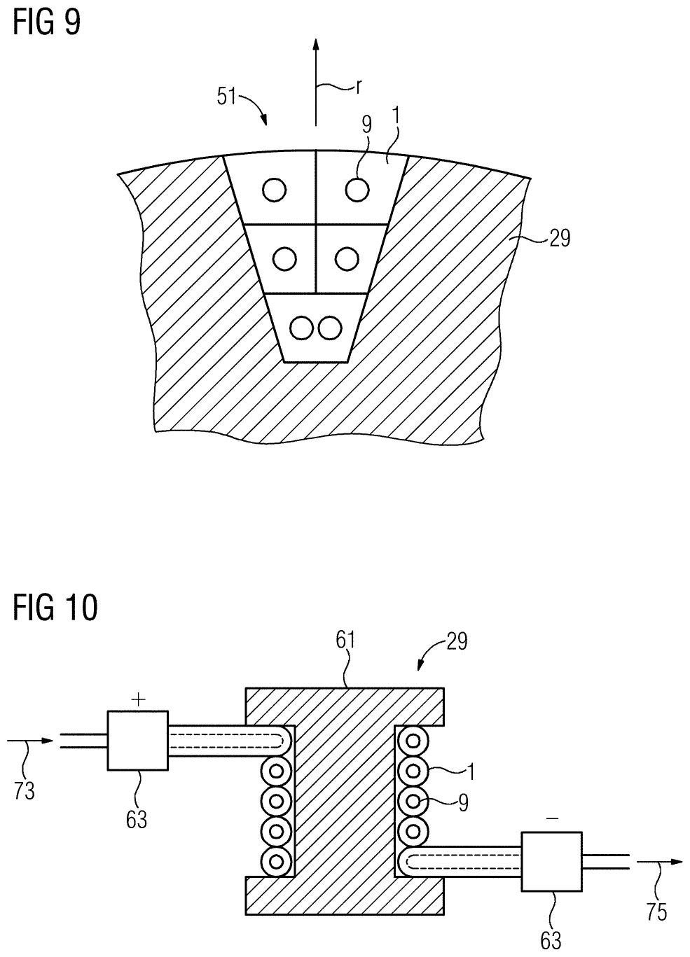

FIG. 9 shows a sectional illustration of a portion of an electrical coil device according to a further example. FIG. 9 shows a region of a stator slot 51 that represents a subregion of a superordinate stator winding. The stator slot 51 is a slot in a soft-magnetic stator yoke 29 into which a plurality of conductor elements are embedded. In the example shown, five conductor elements of this kind are arranged in a manner distributed over three layers. In this case, the size and cross-sectional shape of the individual conductor elements is chosen such that the slot volume may be filled to an optimum extent. To this end, the conductor elements may accordingly have beveled side faces that are configured to match the inclined slot walls. According to the present embodiments, each conductor element has at least one coolant duct 9 that is embedded into the stranded bundle in order to effectively cool the conductors. The conductor element that is furthest on the inside in the radial direction r even has two internal coolant ducts 9 by way of example.

FIG. 10 shows a schematic cross-sectional illustration of an electrical coil device 29 according to a further example of the present embodiments. FIG. 10 shows a toothed coil in which an electrical conductor is wound in several turns about a coil former 61. The coil former 61 may be formed from a soft-magnetic material and, as in the example of FIG. 10, have a dog bone-shaped cross-sectional profile. In this example too, the electrical conductor is produced by way of a stranded bundle having been arranged around an internal core and pressed together with the internal core. The stranded bundle is then filled, for example, with a filler 5, and the filler 5 is cured. However, the intermediate product produced in this way is still flexible enough in order to wind up the toothed coil according to the shape illustrated in FIG. 10. However, as an alternative, the coil winding may also have been wound from a pressed conductor that did not yet contain any filler, where an impregnation agent that simultaneously serves as a filler for the stranded composite is applied during the winding operation. This impregnation agent may have been cured during the winding operation or after the winding operation.

In the example of FIG. 10, the removal of at least a portion of the internal core 7 for forming the internal coolant duct takes place only after the coil winding is shaped in each case. FIG. 10 shows how the internal coolant duct 9 is exposed by way of a material of the internal core, which has a low melting point, being flushed out by a flushing liquid. The flushing liquid may be, for example, a preheated flushing liquid that is flushed through the coil arrangement in accordance with the direction of the arrows 73 and 75, and in this way, removes the readily fusible core material from the interior of the conductor. In order to facilitate this removal and therefore the formation of the coolant duct 9, a current flow through the conductor 1 is also generated by two electrical contact elements 63. As a result of this, the conductor is heated, and the core material that has a low melting point is simultaneously melted out and flushed out. In principle, the manner of melting out and flushing out illustrated here may be carried out for all the described types of electrical conductors and for all shapes of electrical coil devices. This applies irrespective of whether there is an additional pipe wall or not, whether the conductor is still movable after the filler is cured or not, and also irrespective of whether the shaping of the conductor for forming the coil is performed before or after the core material in question is removed.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. An electrical conductor that is configured as a stranded conductor and comprises:
a bundle comprising a number of electrically conductive individual wires, wherein the number of electrically conductive individual wires are connected to one another by a cured filler that fills cavities between the number of electrically conductive individual wires, such that a superordinate conductor structure is formed; and
at least one internal coolant duct that extends along a longitudinal direction of the electrical conductor and is sealed off in a fluid-tight manner from regions of the stranded conductor that are situated further on an outside,
wherein a distance between the at least one internal coolant duct and closest individual wires of the number of electrically conductive individual wires of the bundle is at most 1 mm.

2. The electrical conductor of claim 1, further comprising a pipe wall between the bundle and a coolant duct of the at least one internal coolant duct,
wherein the pipe wall delimits the coolant duct in a fluid-tight manner and has a thickness of at most 1 mm, and
wherein a filling from a region in an interior of the pipe wall is removed, such that the coolant duct is formed.

3. The electrical conductor of claim 2, wherein a material of the pipe wall has a thermal conductivity of at least 5 W/m·K.

4. The electrical conductor of claim 2, wherein a material of the pipe wall is an electrically conductive material, comprises a thermally conductive plastic, comprises a thermally conductive composite material, or any combination thereof.

5. The electrical conductor of claim 1, wherein the at least one internal coolant duct is delimited directly by the bundle that is connected by the cured filler, so that the at least one internal coolant duct is sealed off in a fluid-tight manner by a composite comprising individual wires of the number of electrically conductive individual wires and the filler.

6. The electrical conductor of claim 1, wherein the number of electrically conductive individual wires within the bundle are stranded, braided, or stranded and braided with one another.

7. The electrical conductor of claim 1, wherein the at least one internal coolant duct comprises a plurality of internal coolant ducts.

8. The electrical conductor of claim 1, wherein the number of electrically conductive individual wires within the bundle are pressed together, such that a stable and compact composite is formed.

9. The electrical conductor of claim 1, wherein the electrical conductor is configured as a prefabricated, dimensionally stable conductor segment for a coil device.

10. The electrical conductor of claim 1, wherein the electrical conductor is configured as a malleable conductor for winding an electrical coil.

11. An electrical coil device comprising:
an electrical coil winding comprising:
one or more electrical conductors, an electrical conductor of the one or more electrical conductors being configured as a stranded conductor and comprising:
a bundle comprising a number of electrically conductive individual wires, wherein the number of electrically conductive individual wires are connected to one another by a cured filler that fills cavities between the number of electrically conductive individual wires, such that a superordinate conductor structure is formed; and
at least one internal coolant duct that extends along a longitudinal direction of the electrical conductor and is sealed off in a fluid-tight manner from regions of the stranded conductor that are situated further on an outside,
wherein a distance between the at least one internal coolant duct and closest individual wires of the number of electrically conductive individual wires of the bundle is at most 1 mm.

12. The electrical coil device of claim 11, wherein the electrical coil winding is configured as a hairpin winding.

13. A method for producing an electrical conductor, the method comprising:
arranging a bundle of individual wires around at least one internal elongate core;
jointly pressing the bundle of individual wires and the at least one internal elongate core, such that a composite that is stable and compact is formed;
filling the composite with a filler and then curing the filler; and
forming a coolant duct, forming the coolant duct comprising removing at least a portion of the at least one internal elongate core.

14. The method of claim 13, wherein forming the coolant duct comprises removing an entire core of the at least one internal elongate core or removing an internal portion of the core using a physical, chemical, or physical and chemical process.

15. The method of claim 13, wherein the at least one internal elongate core comprises an external casing and an internal filling (15), and
wherein forming the coolant duct comprises removing only the filling, such that the external casing remains as a pipe wall between the coolant duct and the bundle of individual wires.
